(19) United States
(12) Patent Application Publication
(10) Pub. No.: US 2013/0265891 A1
(43) Pub. Date: Oct. 10, 2013

(54) Transmission Interface and Method for Determining Transmission Signal

(71) Applicants: Wen-Hwa Luo, New Taipei City (TW); Kuan-Han Chen, New Taipei City (TW); Yi-Tsuen Tsai, New Taipei City (TW)

(72) Inventors: Wen-Hwa Luo, New Taipei City (TW); Kuan-Han Chen, New Taipei City (TW); Yi-Tsuen Tsai, New Taipei City (TW)

(21) Appl. No.: 13/561,067

(22) Filed: Jul. 29, 2012

(30) Foreign Application Priority Data
Apr. 9, 2012 (TW) 101112492

(51) Int. Cl. H04L 12/26

(52) U.S. Cl. 370/252

(57) ABSTRACT

A transmission interface coupled to a test device includes a detection module for receiving a test signal of the test device, a processor for generating a control signal, a multiplexer coupled to the detection module and the processor for generating an output signal according to the test signal and the control signal, and an output module for outputting the output signal to a display device so as to process an functional operation corresponding to the test signal. The functional operation includes determination of a maximum operational frequency signal, a clock signal, a transmission data or an operational mode of the test device.

### BACKGROUND OF THE INVENTION

1. Field of the Invention

The present invention relates to a transmission interface and a method for transmission signal determination, and more particularly, to a transmission interface and a method for determining transmission signal including a maximum operational frequency signal, a clock signal, a transmission data or an operational mode.

2. Description of the Prior Art

For electronic product developers, testing and certifying functional operation of the to-be-marketed electronic product are guaranteed. While operating tests or certification measures, users/testers may encounter different transmission interfaces of the electronic products, such as the inter-integrated circuit (I2C) or the serial peripheral interface (SPI). Thus, the users/testers are provided corresponding testing devices/buses such that the different transmission interfaces of the electronic products can be functionally operated with the related tests or certification measures, which results in many corresponding testing devices/buses being purchased against economic issues.

Furthermore, each of the electronic products has its maximum operational frequency, which is unknown before testing. Therefore, the users/testers have no choice but to spend more time gradually adjusting suitable operational frequencies via a manual detection operation, which is time consuming. Besides, each of the transmission interfaces has individual specifically predefined transmission signals. For example, the I2C transmission interface includes a serial data and a serial clock signal being transmitted via individually predefined signal pins. If the testers/users have inadvertently connect the wrong signal pins for signal transmission, they may be unable to continue the following tests or receive a wrong testing result, wasting more available resources.

Therefore, it has become an important issue to provide a universal transmission interface to integrate different testing buses applied to different electronic products, which has advantages of automatically correcting the maximum operational frequency of the electronic products as well as providing error-proof mechanisms while users connect the corresponding signal pins. Better transmission efficiency and wider product application can also be anticipated.

### SUMMARY OF THE INVENTION

It is therefore an objective of the invention to provide a transmission interface and a method for determining transmission signals, so as to integrate different testing buses applied to different electronic products and to automatically detect the maximum operational frequency of the electronic products as well as to provide error-proof mechanisms while users connect the corresponding signal pins.

An embodiment of the invention discloses a transmission interface coupled to a test device comprising a detection module for receiving a test signal of the test device, a processor for generating a control signal, a multiplexer coupled to the detection module and the processor for generating an output signal according to the test signal and the control signal, and an output module for outputting the output signal to a display device to process an functional operation corresponding to the test signal, wherein the functional operation comprises determination of a maximum operational frequency signal, a clock signal, a transmission data or an operational mode of the test device.

An embodiment of the invention also discloses another method for determining transmission signal in a transmission interface coupled to a test device. The method comprises receiving a test signal of the test device, generating a control signal, generating an output signal according to the test signal and the control signal, and outputting the output signal to a display device to process a functional operation corresponding to the test signal, wherein the functional operation comprises determination of a maximum operational frequency signal, a clock signal, a transmission data or an operational mode of the test device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a transmission interface according to an embodiment of the invention.

FIG. 2 illustrates a detailed schematic diagram of the detection module in FIG. 1 according to an embodiment of the invention.

FIG. 3 illustrates a flow chart of a transmission signal determination process according to an embodiment of the invention.

FIG. 4 illustrates a flow chart of an operational frequency signal determination process according to an embodiment of the invention.

FIG. 5 illustrates a flow chart of a data determination process according to an embodiment of the invention.

FIG. 6 illustrates a flow chart of an operational mode determination process according to an embodiment of the invention.

### DETAILED DESCRIPTION

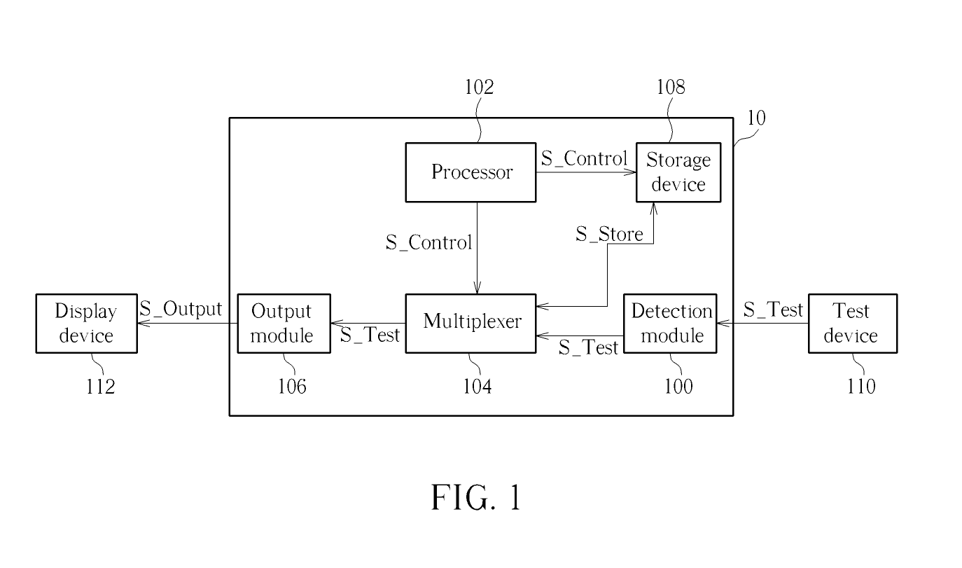

Please refer to FIG. 1, which illustrates a schematic diagram of a transmission interface 10 according to an embodiment of the invention. As shown in FIG. 1, the transmission interface 10 includes a detection module 100, a processor 102, a multiplexer 104, an output module 106 and a storage device 108. The detection module 100 is coupled to a test device 110 to receive a test signal S_Test from the test device 110. The multiplexer 104 is coupled to the processor 102, the output module 106 and the storage device 108, and simultaneously receives a control signal S_Control from the processor 102 and the test signal S_Test from the test device 110. According to the control signal S_Control, the multiplexer 104 transforms the test signal S_Test into a storage signal S_Store outputted to the storage device 108, or outputs the test signal S_Test to the output module 106. The output module 106 transforms the test signal S_Test into an output signal S_Output to be transmitted to a display device 112 for generating a display result. Generally, the transmission interface 10 can be an inter-integrated circuit (I2C), a serial peripheral interface (SPI), a security digital (SD) transmission interface or an embedded multimedia card (EMMC) transmission interface, so as to process signal transmission with the test device 110. In the embodiment, when a tester connects the transmission interface 10 to the test device 110, the display device 112 shows the display result thereon to process a functional operation of the test device 110. The type of the test signal S_Test generated by the test device 110 is determined by the functional operation. Different functions corresponding to the type of the test signal S_Test will be described below.

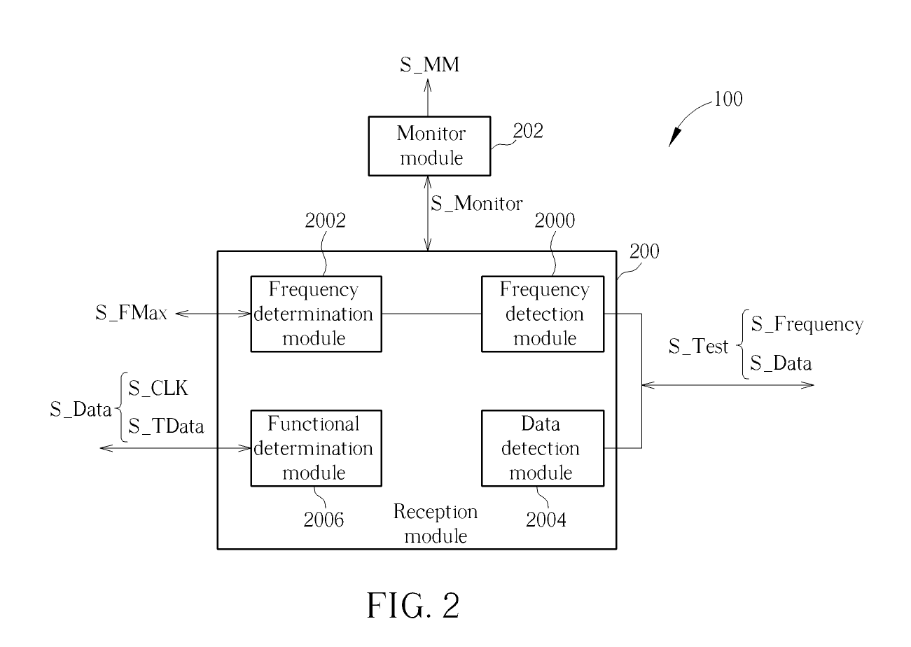

Please refer to FIG. 2, which illustrates a detailed schematic diagram of the detection module 100 in FIG. 1 according to an embodiment of the invention. As shown in FIG. 2, the detection module 100 includes a reception module 200 and a monitor module 202. The reception module 200 further includes a frequency detection module 2000, a frequency determination module 2002, a data detection module 2004 and a functional determination module 2006. In detail, the reception module 200 receives the test signal S_Test including an operational frequency signal S_Frequency and/or a data signal S_Data. The operational frequency signal S_Frequency and the data signal S_Data are received by the frequency detection module 2000 and the data detection module 2004, respectively. After the frequency detection module 2000 receives the operational frequency signal S_Frequency, the frequency determination module 2002 generates an acknowledgement signal according to the current operational frequency signal S_Frequency, and the acknowledgement signal is transmitted back to the test device 110 via the frequency detection module 2000. Under such circumstances, the test device 110 outputs another larger value of the operational frequency signal S_Frequency to the frequency detection module 2000. Until the frequency determination module 2002 determines the current operational frequency signal S_Frequency is the proper operational frequency, i.e. the maximum operational frequency value, the frequency determination module 2002 stops the above operation to output the maximum operational frequency signal S_FMax. In other words, the maximum operational frequency signal S_FMax of the test device 110 can be automatically determined via the frequency detection module 2000 and the frequency determination module 2002 without redundant manual correction operations by the tester.

According to different transmission interfaces, the data signal S_Data includes different composition signals, such as a clock signal S_CLK and a transmission data S_TData for the I2C transmission interface, or a clock signal SCLK, a MOSI/SIMO signal and a chip-select (SC) signal for the SPI. Hereinafter, the embodiment of the invention is demonstrated via the I2C transmission interface, and is not limiting the scope of the invention. According to the same conception of the invention, additional reception modules and determination modules for related transmission signals are required for other transmission interfaces, so as to combine the embodiment with the SPI, the SD transmission interface and the EMMC transmission interface, and so on. Also, the data detection module 2004 simultaneously receives the mixing data signals S_Data including the clock signal S_CLK and the transmission data S_TData, and the functional determination module 2006 determines which is inside the data signals S_Data, which means that it is not necessary for the tester to determine in advance the kind of signal pins used for the test device 110. The user directly connects the plurality of the signal pins transmitting the clock signal S_CLK and the transmission data S_TData to the test module 100, and then the data detection module 2004 as well as the functional determination module 2006 can be utilized to classify the kinds of the transmission signals via the signal pins, which also avoids human neglect/error resulting in failure of the functional operation of the transmission interface 10.

Moreover, the monitor module 202 and the reception module 200 utilize a detection signal S_Monitor to instantaneously monitor whether the test device 110 is processing the transmission operation of the test signal S_Test, and then the monitor module 202 correspondingly outputs a monitor result S_MM. If the test device 110 is processing the transmission operation of the test signal S_Test, the monitor module 202 determines the test device is in an operational mode, so as to provide related information to the processor 102 and the multiplexer 104. If the test device 110 is not processing the transmission operation of the test signal S_Test, the monitor module 202 determines the test device is in a sleep mode, so as to command the processor 102 and the multiplexer 104 for power saving and to wait another test signal S_Test from the test device 110. In other words, according to the monitor result S_MM of the monitor module 202, the transmission interface 10 can correctly determine whether the test device 110 is operating to transmit the test signal S_Test, so as to improve following operations of the processor 102 and the multiplexer 104 and to dynamically switch the transmission interface 10 between the operational mode or the sleep mode.

Noticeably, the embodiment of the invention utilizes the reception module 200 with the monitor module 202 for functional operations, wherein the reception module 200 includes the frequency detection module 2000, the frequency determination module 2002, the data detection module 2004 and the functional determination module 2006. According to different users' requirements or different buses applied to the test device 110, the reception module 200 can be utilized to determine the maximum operational frequency signal S_FMax of the test device 110, i.e. the reception module 200 only includes the frequency detection module 2000 and the frequency determination module 2002, or to determine the data signal S_Data of the test device 110, i.e. the reception module 200 only includes the data detection module 2004 and the functional determination module 2006, so as to simplify circuit design and cost of the reception module 200, which is also in the scope of the invention. Accordingly, the storage device 108 adaptively stores the maximum operational frequency signal S_FMax and/or the data signal S_Data according to the control signal S_Control generated by the processor 102 to immediately refresh the storage therein. Certainly, the storage device 108 can transmit the storage signal S_Store to the multiplexer 104 via the control signal S_Control as another comparison/correction operation, and related realization should be familiar to those skilled in the art and is not described hereinafter. Besides, techniques for the display device 112 to generate the display result can be realized via a liquid crystal display (LCD) device or a notebook computer to correspondingly generate the display result of the test signal S_Test for the user processing the above functional operations, which is also in the scope of the invention.

The detection module 100 utilizes the reception module 200 and the monitor module 202 to output the maximum operational frequency signal S_FMax, the data signal S_Data including the clock signal S_CLK and the transmission data S_TData, and the monitor result S_MM of the test signal S_Test to the multiplexer 104, and, accordingly, the processor 102 outputs the control signal S_Control to transform the test signal S_Test into the storage signal S_Store to be stored inside the storage device 108 or to be directly outputted to the output module 106 via the multiplexer 104. Next, the display device 112 receives and displays the display result of the output signal S_Output, so as to process the functional operations based on the test signal S_Test for the users. For example, the functional operations can be determination of the maximum operational frequency signal S_FMax, determination of the data signal S_Data from different signal pins, or the current operational mode (i.e. the monitor result S_MM) of the test device 110. Therefore, the tester only needs to connect the test device 100 to the transmission interface 10 and the plurality of functional operations can be individually completed, which not only integrates different buses applied to different electronic products, but also prevents errors of connecting signal sources with wrong signal pins. In comparison with the prior art, the embodiment of the invention provides better transmission efficiency and wider product application.

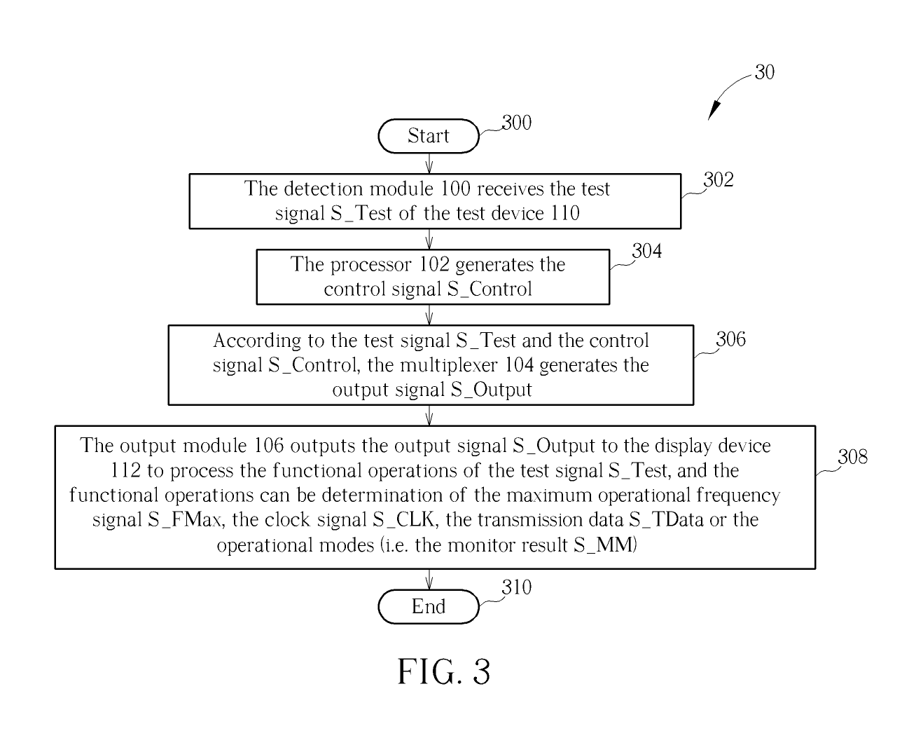

Further, the operation of the transmission interface 10 according to an embodiment of the invention can be summarized as a transmission signal determination process 30, as shown in FIG. 3. The transmission signal determination process 30 includes the steps as follows:

Step 300: Start.

Step 302: The detection module 100 receives the test signal S_Test of the test device 110.

Step 304: The processor 102 generates the control signal S_Control.

Step 306: According to the test signal S_Test and the control signal S_Control, the multiplexer 104 generates the output signal S_Output.

Step 308: The output module 106 outputs the output signal S_Output to the display device 112 to process the functional operations of the test signal S_Test, and the functional operations can be determination of the maximum operational frequency signal S_FMax, the clock signal S_CLK, the transmission data S_TData or the operational modes (i.e. the monitor result S_MM).

Step 310: End.

Noticeably, the transmission signal determination process 30 generates the different functional operations according to the test signal S_Test from different test devices 110. Thus, the maximum operational frequency signal S_FMax, the clock signal S_CLK, the transmission data S_TData or the operational modes (i.e. the monitor result S_MM) demonstrated in Step 308 are utilized to fit the I2C for transmission process between the transmission interface 10 and the test device 110. If the transmission interface 10 and the test device 110 share the transmission process via the SPI, the SD transmission interface or the EMMC transmission interface, different appropriate signals can be correspondingly generated/added, which is not limiting the scope of the invention.

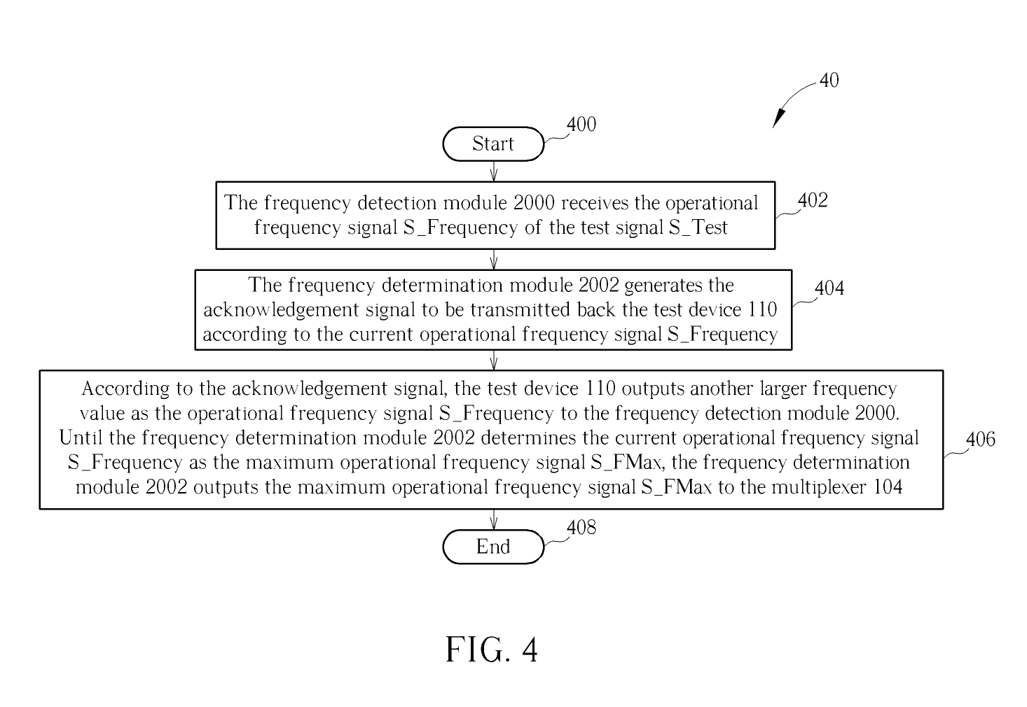

Further, operation of the transmission signal determination process 30 to determine the maximum operational frequency signal S_FMax can be summarized as an operational frequency signal determination process 40, as shown in FIG. 4. The operational frequency signal determination process 40 includes the steps as follows:

Step 400: Start.

Step 402: The frequency detection module 2000 receives the operational frequency signal S_Frequency of the test signal S_Test.

Step 404: The frequency determination module 2002 generates the acknowledgement signal to be transmitted back the test device 110 according to the current operational frequency signal S_Frequency.

Step 406: According to the acknowledgement signal, the test device 110 outputs another larger frequency value as the operational frequency signal S_Frequency to the frequency detection module 2000. Until the frequency determination module 2002 determines the current operational frequency signal S_Frequency as the maximum operational frequency signal S_FMax, the frequency determination module 2002 outputs the maximum operational frequency signal S_FMax to the multiplexer 104.

Step 408: End.

The detailed steps of the operational frequency signal determination process 40 can be understood via FIG. 1 to FIG. 3, the transmission interface 10 as well as transmission signal determination process 30 and the related paragraphs, which is not described hereinafter.

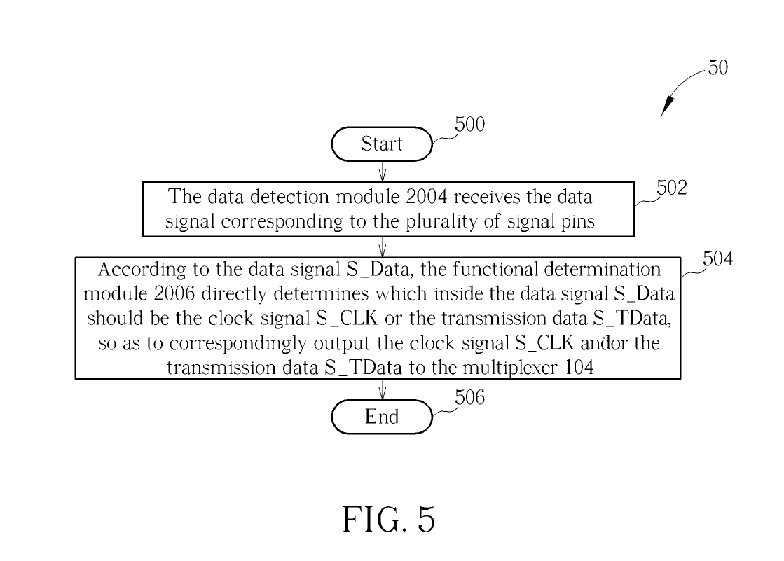

Further, operation of the transmission signal determination process 30 to determine the clock data S_CLK and the transmission data S_TData can be summarized as a data determination process 50, as shown in FIG. 5. The data determination process 50 includes the steps as follows:

Step 500: Start.

Step 502: The data detection module 2004 receives the data signal corresponding to the plurality of signal pins.

Step 504: According to the data signal S_Data, the functional determination module 2006 directly determines which inside the data signal S_Data should be the clock signal S_CLK or the transmission data S_TData, so as to correspondingly output the clock signal S_CLK and/or the transmission data S_TData to the multiplexer 104.

Step 506: End.

The detailed steps of the data determination process 50 can be understood via FIG. 1 to FIG. 3, the transmission interface 10 as well as transmission signal determination process 30 and the related paragraphs, which is not described hereinafter. In Step 502 and Step 504, the data signals S_Data from the plurality of signal pins may include other transmission data signals based on different transmission interfaces, which is not limiting the scope of the invention.

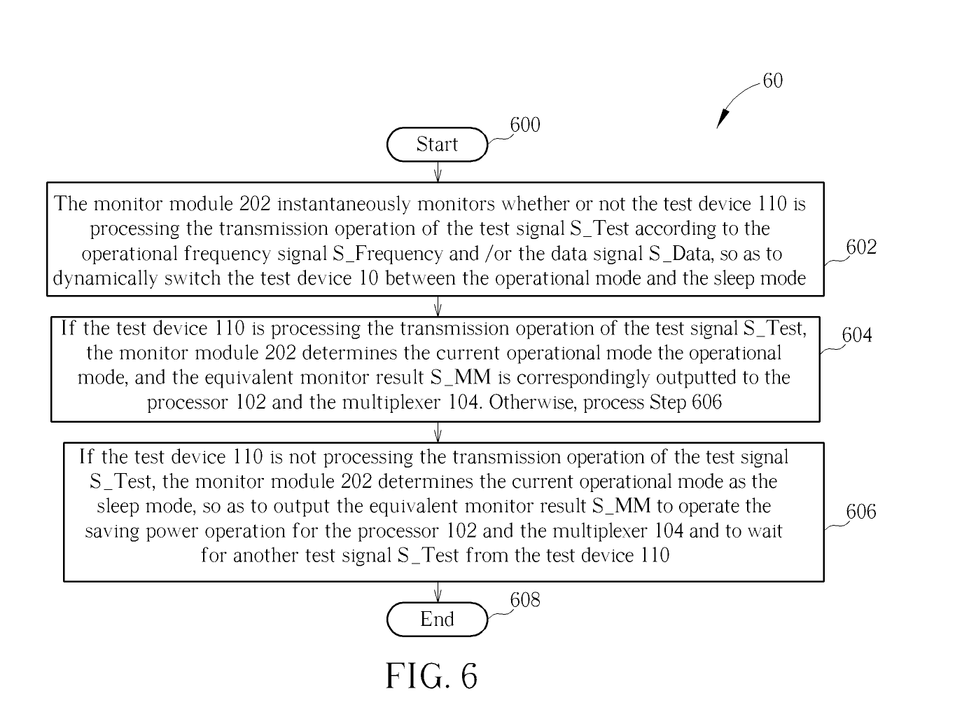

Further, operation of utilizing the monitor module 202 to determine the current operational mode of the test device 110 can be summarized as an operational mode determination process 60, as shown in FIG. 6. The operational mode determination process 60 includes the steps as follows:

Step 600: Start.

Step 602: The monitor module 202 instantaneously monitors whether or not the test device 110 is processing the transmission operation of the test signal S_Test according to the operational frequency signal S_Frequency and/or the data signal S_Data, so as to dynamically switch the test device 10 between the operational mode and the sleep mode.

Step 604: If the test device 110 is processing the transmission operation of the test signal S_Test, the monitor module 202 determines the current operational mode the operational mode, and the equivalent monitor result S_MM is correspondingly outputted to the processor 102 and the multiplexer 104. Otherwise, process Step 606.

Step 606: If the test device 110 is not processing the transmission operation of the test signal S_Test, the monitor module 202 determines the current operational mode as the sleep mode, so as to output the equivalent monitor result S_MM to operate the saving power operation for the processor 102 and the multiplexer 104 and to wait for another test signal S_Test from the test device 110.

Step 608: End.

The detailed steps of the operational mode determination process 60 can be understood via FIG. 1 to FIG. 3, the transmission interface 10 as well as transmission signal determination process 30 and the related paragraphs, which is not described hereinafter. Those skilled in the art can combine the conceptions of the transmission interface 10 as well as the transmission signal determination process 30 to connect the single transmission interface 10 with a plurality of test devices 110, so as to generate different display results onto a plurality of display device 112 according to the plurality of test devices 110. Further, the tester can combine a plurality of transmission interfaces 10 processing different functional operations based on the conception of the operational mode determination process 60 to dynamically switch the plurality of transmission interfaces 10 between the operational mode and the sleep mode, which is also in the scope of the invention.

In summary, the invention provides an transmission interface which receives a test signal of a test device via a detection module and determines a plurality of functional operations corresponding to the test signal via a reception module and a monitor module, such that a tester can process the functional operations, such as determining a maximum operational frequency signal, a clock signal, a transmission data or an operational mode (i.e. a monitor result), via a display device. In comparison with the prior art, different transmission buses can be integrated to broaden the product application among different electronic products, and the maximum operational frequency of the electronic products can be automatically detected/determined. Also, possible errors of connecting signal sources to wrong signal pins can be prevented to provide better transmission efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmission interface coupled to a test device comprising:
a detection module for receiving a test signal of the test device;
a processor for generating a control signal;
a multiplexer coupled to the detection module and the processor for generating an output signal according to the test signal and the control signal; and
an output module for outputting the output signal to a display device, so as to process an functional operation corresponding to the test signal, wherein the functional operation comprises determination of a maximum operational frequency signal, a clock signal, a transmission data or an operational mode of the test device.

2. The transmission interface of claim 1, wherein the detection module further comprises a reception module for receiving the test signal.

3. The transmission interface of claim 2, wherein the test signal is an operational frequency signal or a data signal.

4. The transmission interface of claim 3, wherein the detection module further comprises a frequency detection module for receiving the operational frequency signal.

5. The transmission interface of claim 4, wherein the detection module further comprises a frequency determination module for outputting the maximum operational frequency signal according to the operational frequency signal.

6. The transmission interface of claim 3, wherein the detection module further comprises a data detection module for receiving the data signal.

7. The transmission interface of claim 6, wherein the data signal comprises at least the clock signal or the transmission data.

8. The transmission interface of claim 7, wherein the detection module further comprises a functional determination module for generating a determination result according to the clock signal or the transmission data corresponding to the data signal.

9. The transmission interface of claim 1, wherein the detection module further comprises a monitor module for monitoring the operational mode of the test device.

10. The transmission interface of claim 1, further utilized in an inter-integrated circuit interface, a serial peripheral interface, a security card interface or an embedded multimedia card interface.

11. The transmission interface of claim 1, further comprising a storage device for storing the test signal according to the control signal.

12. The transmission interface of claim 1, wherein the output signal is utilized to generate a display result on the display device, so as to provide the functional operation for the test device.

13. A method for determining transmission signal in a transmission interface coupled to a test device, the method comprising:
receiving a test signal of the test device;
generating a control signal;
generating an output signal according to the test signal and the control signal; and
outputting the output signal to a display device, so as to process a functional operation corresponding to the test signal, wherein the functional operation comprises determination of a maximum operational frequency signal, a clock signal, a transmission data or an operational mode of the test device.

14. The method of claim 13, wherein the test signal is an operational frequency signal or a data signal.

15. The method of claim 14, further comprising outputting the maximum operational frequency signal according to the operational frequency signal.

16. The method of claim 14, wherein the data signal comprises at least the clock signal or the transmission data.

17. The method of claim 16, further comprising generating a determination result according to the clock signal or the transmission data corresponding to the data signal.

18. The method of claim 13, further comprising monitoring the operational mode of the test device.

19. The method of claim 13, further comprising utilizing the transmission interface in an inter-integrated circuit interface, a serial peripheral interface, a security card interface or an embedded multimedia card interface.

20. The method of claim 13, further comprising utilizing the output signal to generate a display result on the display device, so as to provide the functional operation for the test device.
